(19) United States
(12) Patent Application Publication
(10) Pub. No.: US 2024/0320389 A1
(43) Pub. Date: Sep. 26, 2024

(54) METHOD AND DEVICE FOR DETERMINING DIVIDING POSITION AND INTEGRATION OF AUTOMOTIVE PART

(71) Applicant: JFE STEEL CORPORATION, Tokyo (JP)

(72) Inventor: Takanobu SAITO, Tokyo (JP)

(73) Assignee: JFE STEEL CORPORATION, Tokyo (JP)

(21) Appl. No.: 18/271,741

(22) PCT Filed: Oct. 1, 2021
(86) PCT No.: PCT/JP2021/036447

§ 371 Date: Jul. 11, 2023

(30) Foreign Application Priority Data
Jan. 27, 2021 (JP) 2021-010843

(51) Int. Cl. G06F 30/20; G06F 30/15; G06F 111/04; G06F 111/06; G06F 111/20

(52) U.S. Cl. CPC G06F 30/20; G06F 30/15; G06F 2111/04; G06F 2111/06; G06F 2111/20

(57) ABSTRACT

A dividing position and integration of automotive parts determination method includes: acquiring an automotive body model including automotive parts modeled by elements and joining points at which the automotive parts are joined as a parts assembly; setting objectives related to automotive body performance of the automotive body model, constraints related to a volume of the automotive body model, and load and constraint condition or only loading condition given to the automotive body model, and obtaining sensitivity of each of the elements in each of the automotive parts satisfying the objectives under the load and constraint condition or only the loading condition and the constraints; and determining a position where the automotive part is divided and/or the automotive parts to be integrated based on the sensitivity of each of the elements in each of the automotive part.

### FIELD

The present invention relates to a method and a device for determining a dividing position and integration of automotive parts, with which a dividing position of an automotive part is reviewed and optimized for an automotive body, the automotive body including a plurality of automotive parts and being given in advance joining points at which automotive parts are joined as a parts assembly, and particularly relates to a method and a device for determining a dividing position and integration of automotive parts, the method and the device capable of efficiently improving automotive body performance of an automobile or the like.

### BACKGROUND

In recent years, weight reduction of automotive bodies due to environmental problems has been promoted particularly in the automobile industry, and computer aided engineering (CAE) analysis has become essential technology for the design of automotive bodies. In this CAE analysis, stiffness analysis, crashworthiness analysis, vibration analysis, and the like are performed, which greatly contribute to improvement of the automotive body performance.

In addition, in CAE analysis, it is known that various types of automotive body performance can be improved and that the weight can be reduced by using not only simple performance evaluation but also optimization analysis technology such as mathematical optimization, dimension optimization, shape optimization, and topology optimization. As such optimization analysis technology, for example, Patent Literature 1 discloses a method for topology optimization of components of a complicated structural body.

Furthermore, Patent Literature 2 discloses a method of performing sensitivity analysis of automotive parts with respect to automotive body performance using the optimization analysis technology and clarifying automotive parts to be subjected to measures for improving the automotive body performance based on the result of the sensitivity analysis.

### CITATION LIST

### Patent Literature

Patent Literature 1: JP 2010-250818 A
Patent Literature 2: JP 2020-60820 A

### SUMMARY

### Technical Problem

The method disclosed in Patent Literature 2 models automotive parts, calculates sensitivity to the automotive body performance of each element used in the model by sensitivity analysis, obtains sensitivity for each automotive part based on the calculated sensitivity of each element, and clarifies an automotive part to be subjected to measures such as changing the sheet thickness or a material property.

In the method, dividing positions of the automotive parts are given and fixed in advance, and since the magnitude of sensitivity is determined for each of the automotive parts even in a case where there is a distribution of sensitivity in the same automotive part, the sheet thickness or a material property of an automotive part, which has been determined to be applied with a measure, is modified. Therefore, even in an automotive part whose sheet thickness or the like has been determined to be modified, there may be a portion where the sheet thickness or the like should not be modified in the automotive part, however, since the dividing positions are fixed, there are cases where the automotive body performance is not sufficiently improved even after the sheet thickness or the like of the automotive part is modified.

Therefore, if the positions at which the automotive body is divided into the plurality of automotive parts are modified, and the sheet thickness or a material property are appropriately set for each of the automotive parts that have been newly divided or integrated by the modification, it is conceivable that the automotive body performance can be efficiently improved.

As a method of determining division or integration of automotive parts, a method of determining division or integration based on the stress or strain generated by a load applied to the automotive parts is conceivable. In this method, it is possible to determine a boundary between a portion having a large stress or the like and a portion having a small stress or the like in an automotive part as a dividing position and to integrate automotive parts having the same level of stress or the like.

However, even in a case where the dividing positions, the sheet thickness, or the like of automotive parts to be integrated are modified by the method, there are cases where the performance of the automotive parts are improved whereas the performance of adjacent automotive parts are deteriorated, and it is not guaranteed that the performance of the entire automotive body is improved. Therefore, the automotive body performance cannot be efficiently and sufficiently improved.

The present invention has been made in view of the above disadvantages, and an object of the present invention is to provide a method and a device for determining a dividing position and integration of automotive parts that can efficiently and sufficiently improve the automotive body performance.

### Solution to Problem

A dividing position and integration of automotive parts determination method according to the present invention determines a dividing position of an automotive part and/or automotive parts to be integrated by the following steps executed by a computer for an automotive body model including a plurality of the automotive parts, and includes: an automotive body model acquiring step of acquiring the automotive body model including the plurality of automotive parts modeled by a plurality of elements and joining points at which the plurality of automotive parts are joined as a parts assembly; a sensitivity analysis step of setting objectives related to automotive body performance of the automotive body model, constraints related to a volume of the automotive body model, and load and constraint condition or only loading condition given to the automotive body model, and obtaining sensitivity of each of the elements in each of the automotive parts satisfying the objectives under the load and constraint condition or only the loading condition and the constraints; and an automotive part dividing position and integration determining step of determining a position where the automotive part is divided and/or the automotive parts to be integrated based on the sensitivity of each of the elements in each of the automotive part.

In the sensitivity analysis step, element densities of each of the elements satisfying the objectives may be calculated, and the calculated element densities may be used as the sensitivity of each of the elements.

In the automotive body model acquiring step, all additional joining points at which the parts assembly may be able to be joined is set to the acquired automotive body model in addition to the joining points.

A dividing position and integration of automotive parts determination device according to the present invention determines a dividing position of an automotive part and/or automotive parts to be integrated for an automotive body model including a plurality of the automotive parts, and includes: an automotive body model acquiring unit configured to acquire the automotive body model including the plurality of automotive parts modeled by a plurality of elements and a joining point at which the plurality of automotive parts are joined as a parts assembly; a sensitivity analysis unit configured to set objectives related to automotive body performance of the automotive body model, constraints related to a volume of the automotive body model, and load and constraint condition or only loading condition given to the automotive body model, and obtain sensitivity of each of the elements in each of the automotive parts satisfying the objectives under the load and constraint condition or only the loading condition and the constraints; and an automotive part dividing position and integration determining unit configured to determine a position where the automotive part is divided and/or the automotive parts to be integrated by an instruction of an operator based on the sensitivity of each of the elements in each of the automotive parts.

The sensitivity analysis unit may be configured to calculate element densities of each of the elements in each of the automotive parts satisfying the objectives, and use the calculated element densities as the sensitivity of each of the elements.

The automotive body model acquiring unit may be configured to set all additional joining points at which the parts assembly is able to be joined to the acquired automotive body model in addition to the joining points.

### Advantageous Effects of Invention

According to the present invention, sensitivity to the automotive body performance can be obtained for each of elements used for modeling automotive parts, and optimum dividing positions of the automotive parts and automotive parts to be integrated can be determined by reviewing previously given dividing positions of the automotive parts based on the obtained sensitivity of each of the elements in the automotive parts. By modifying the sheet thickness or a material property as appropriate for each new automotive part obtained from the division or the integration, the automotive body performance can be efficiently and sufficiently improved.

### BRIEF DESCRIPTION OF DRAWINGS

FIG. 1 is a block diagram of a division and integration determining device that determines a dividing position and integration of automotive parts according to an embodiment of the present invention.

FIG. 2 is a diagram illustrating an automotive body model to be analyzed in the embodiment of the present invention.

FIG. 3 is a diagram illustrating joining points in an automotive body model to be analyzed and all additional joining points that can be joined in the embodiment of the present invention ((a) preset joining points, (b) all additional joining points that can be joined).

FIG. 4 is a diagram illustrating an example of load and constraint condition given to an automotive body model in the embodiment of the present invention.

FIG. 5 is a diagram illustrating an example in which dividing positions and integration of automotive parts are determined based on a result of sensitivity analysis of automotive parts (A-pillar) on a front side of the automotive body model and element densities obtained as sensitivity by the sensitivity analysis in the embodiment of the present invention ((a) side view of the front side of the original automotive body model given in advance, (b) element densities obtained by sensitivity analysis, and (c) side view of the front side of the automotive body model after division and integration).

FIG. 6 is a diagram illustrating an example in which dividing positions and integration of automotive parts are determined based on a result of sensitivity analysis of automotive parts on a rear side of the automotive body model and element densities obtained as sensitivity by the sensitivity analysis in the embodiment of the present invention ((a) top view of the rear side of the original automotive body model given in advance, (b) element densities obtained by sensitivity analysis, and (c) top view of the rear side of the automotive body model after division and integration).

FIG. 7 is a diagram illustrating an example in which dividing positions and integration of automotive parts are determined based on a result of sensitivity analysis of automotive parts (side sill outer) on a left side of the automotive body model and element densities obtained as sensitivity by the sensitivity analysis in the embodiment of the present invention ((a) perspective view of the left side of the original automotive body model given in advance, (b) element densities obtained by sensitivity analysis, and (c) perspective view of the left side of the automotive body model after division and integration).

FIG. 8 is a diagram illustrating an example of a divided and integrated automotive body model in which dividing positions and integration of automotive parts are determined in the embodiment of the present invention ((a) original automotive body model given in advance, (b) divided and integrated automotive body model after division and integration).

FIG. 9 is a flowchart illustrating a processing flow of a dividing position and integration of automotive parts determination method according to the embodiment of the present invention.

FIG. 10 is a diagram illustrating an example in which dividing positions and integration of automotive parts are determined based on a result of sensitivity analysis of automotive parts on a front side of an automotive body model and element densities obtained as sensitivity by the sensitivity analysis in another aspect of the embodiment of the present invention ((a) side view of the front side of the original automotive body model given in advance, (b) element densities obtained by sensitivity analysis, and (c) side view of the front side of the automotive body model after division and integration).

FIG. 11 is a diagram illustrating an example in which dividing positions and integration of automotive parts are determined based on a result of sensitivity analysis of automotive parts on a rear side of the automotive body model and element densities obtained as sensitivity by the sensitivity analysis in the other aspect of the embodiment of the present invention ((a) top view of the rear side of the original automotive body model given in advance, (b) element densities obtained by sensitivity analysis, and (c) top view of the rear side of the automotive body model after division and integration).

FIG. 12 is a diagram illustrating an example in which dividing positions and integration of automotive parts are determined based on a result of sensitivity analysis of automotive parts on a left side of the automotive body model and element densities obtained as sensitivity by the sensitivity analysis in the other aspect of the embodiment of the present invention ((a) perspective view of the left side of the original automotive body model given in advance, (b) element densities obtained by sensitivity analysis, and (c) perspective view of the left side of the automotive body model after division and integration).

FIG. 13 is a diagram illustrating an example of a divided and integrated automotive body model in which dividing positions and integration of automotive parts are determined in the other aspect of the embodiment of the present invention ((a) original automotive body model given in advance, (b) divided and integrated automotive body model after division and integration).

### DESCRIPTION OF EMBODIMENTS

Prior to describing an embodiment of the present invention, an automotive body model targeted in the present invention will be described.

### <Automotive Body Model>

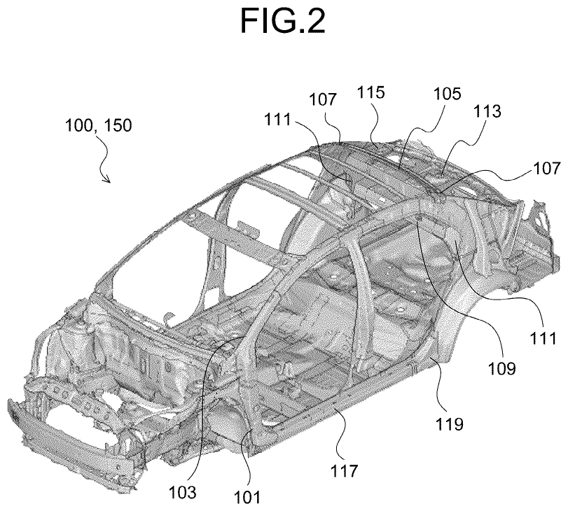

An automotive body model 100 targeted in the present invention includes a plurality of automotive parts as illustrated in FIG. 2 as an example. Those conceivable as the automotive parts include body frame parts such as an A-pillar lower 101, an A-pillar upper 103, a rear roof rail center 105, a rear roof rail side 107, a compartment center A 109, a compartment side A 111, a compartment center B 113, a compartment side B 115, a side sill outer 117, and a wheel house reinforcement 119, suspension parts (not illustrated) such as suspension parts, and others. These automotive parts are modeled by a plurality of shell elements and/or solid elements.

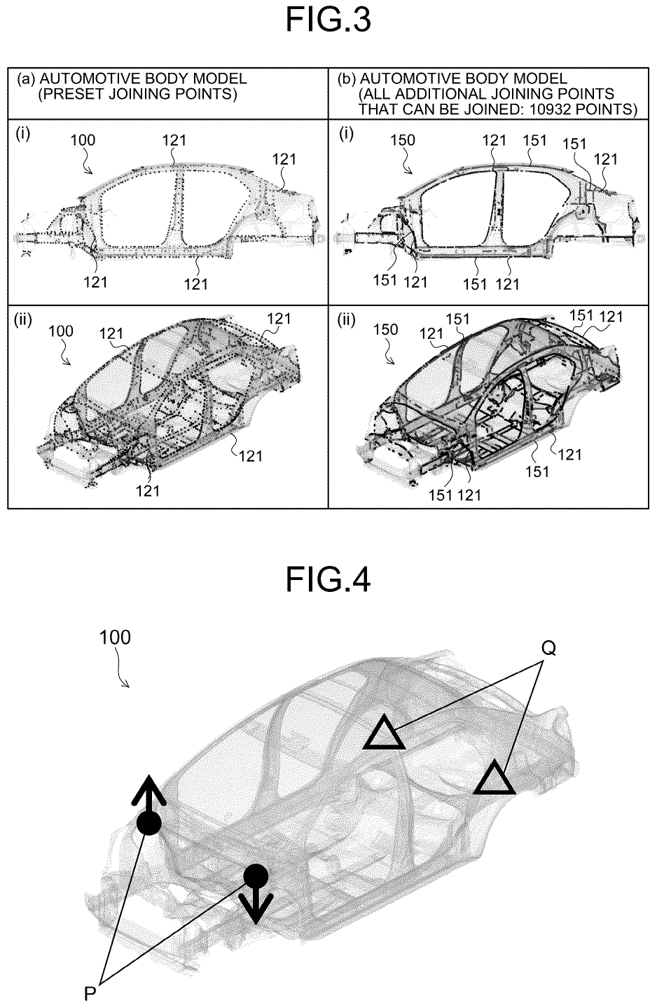

Furthermore, in the automotive body model 100, as illustrated in FIG. 3(a) as an example, joining points 121 where a plurality of automotive parts is joined as a parts assembly are set at predetermined intervals. In the automotive body model 100, the joining points 121 are set at intervals of 25 to 60 mm.

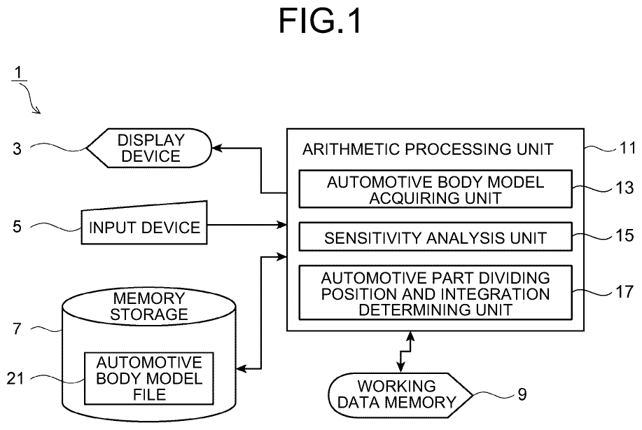

Note that material property or element information of individual automotive parts included in the automotive body model 100 as well as information regarding the joining points 121 (FIG. 2(a)) and the like in each piece of the parts assembly are stored in an automotive body model file 21 (see FIG. 1) to be described later.

### <Division and Integration Determining Device>

A configuration of a division and integration determining device that determines a dividing position and integration of automotive parts according to the embodiment of the present invention will be described below.

A division and integration determining device 1 according to the present embodiment determines a dividing position of an automotive part and/or automotive parts to be integrated for an automotive body model including a plurality of automotive parts. As illustrated in FIG. 1, the division and integration determining device 1 according to the present embodiment includes a personal computer (PC) or the like and includes a display device 3, an input device 5, a memory storage 7, a working data memory 9, and an arithmetic processing unit 11. Then, the display device 3, the input device 5, the memory storage 7, and the working data memory 9 are connected to the arithmetic processing unit 11, and individual functions are executed by a command from the arithmetic processing unit 11.

Hereinafter, each of the components of the division and integration determining device 1 according to the present embodiment will be described for a case where the automotive body model 100 illustrated in FIGS. 2 and 3 is set as an analysis target and a dividing position of an automotive part included in the automotive body model 100 and automotive parts to be integrated are determined.

### <<Display Device>>

The display device 3 is used for displaying an analysis result or the like and includes an LCD monitor or the like.

### <<Input Device>>

The input device 5 is used for a display instruction of the automotive body model file 21, condition input by an operator, and others and includes a keyboard, a mouse, and the like.

### <<Memory Storage>>

The memory storage 7 is used for storing various files such as the automotive body model file 21 in which various types of information related to the automotive body model are recorded as will be described later and includes a hard disk or the like.

### <<Working Data Memory>>

The working data memory 9 is used for temporary storage and calculation of data used by the arithmetic processing unit 11 and includes a random access memory (RAM) or the like.

### <<Arithmetic Processing Unit>>

As illustrated in FIG. 1, the arithmetic processing unit 11 includes an automotive body model acquiring unit 13, a sensitivity analysis unit 15, and an automotive part dividing position and integration determining unit 17 and includes a central processing unit (CPU) such as a PC. Each of these units functions with the CPU executing a predetermined program. The functions of the above units in the arithmetic processing unit 11 will be described below.

### (Automotive Body Model Acquiring Unit)

The automotive body model acquiring unit 13 acquires the automotive body model 100 including automotive parts (such as the A-pillar lower 101) modeled by a plurality of elements and the joining points 121 where the plurality of automotive parts is joined as the parts assembly as illustrated in FIGS. 2 and 3(a).

In the present embodiment, it is based on the premise that each of the automotive parts included in the automotive body model 100 is modeled by a shell element as an example, and information regarding the shell element included in each of the automotive parts and material property (such as Young's modulus, specific gravity, and Poisson's ratio) of each of the automotive parts is recorded in the automotive body model file 21 (see FIG. 1) stored in the memory storage 7. Therefore, the automotive body model acquiring unit 13 can acquire the automotive body model 100 by reading the automotive body model file 21.

### (Sensitivity Analysis Unit)

The sensitivity analysis unit 15 sets objectives regarding the automotive body performance of the automotive body model 100, constraints regarding the volume of the automotive body model 100, and load and constraint condition or only loading condition given to the automotive body model 100 and obtains the sensitivity of each of the elements in each of the automotive parts satisfying the objectives under the load and constraint condition or only the loading condition and the constraints that have been set.

In the present embodiment, the objectives regarding the automotive body performance set by the sensitivity analysis unit 15 include minimization of the total strain energy, minimization of displacement, minimization of stress, maximization of stiffness, and the like in the automotive body model 100, and it is only required to select these objectives as appropriate depending on the target automotive body performance.

Furthermore, as constraints regarding the volume of the automotive body model 100 set by the sensitivity analysis unit 15, for example, there is a volume fraction ratio that defines the volume of the automotive parts.

As the load and constraint condition set to the automotive body model 100 by the sensitivity analysis unit 15, for example, load and constraint condition exemplified in FIG. 4 is set. The load and constraint condition illustrated in FIG. 4 is that attachment positions (P in the drawing) of left and right front suspensions of the automotive body model 100 are set as load points, that a vertically upward load is applied to one of the attachment positions while a vertically downward load is applied to the other attachment position, and that attachment positions (Q in the drawing) of left and right rear subframes of the automotive body model 100 are constrained.

Furthermore, in the present embodiment, it is desirable that the sensitivity analysis unit 15 calculates element densities of each of the elements as the sensitivity of each of the elements in each of the automotive parts by using topology optimization to which densimetry is applied. The element densities of each of the elements calculated in this case correspond to a density p expressed in Equation (1).

$$F = ρ Kx \qquad ( 1 )$$

F: Load vector
p: Normalized density
K: Stiffness matrix
x: Displacement vector

The normalized density ρ in Equation (1) is a virtual density representing the filling state of the material in each of the elements and has a value in a range of 0 to 1. That is, if the element density ρ of an element is 1, it represents a state in which the element is fully filled with a material, if the element density ρ is 0, it represents a state in which the element is not filled with a material and is completely hollow, and if the element density of the element is an intermediate value between 0 and 1, it represents an intermediate state in which the element is neither the material nor hollow.

Furthermore, the element density calculated by topology optimization has a value close to 1 in an element having a large contribution to the automotive body performance, which indicates high sensitivity to the automotive body performance. On the other hand, the element density of an element having a small contribution to the automotive body performance has a value close to 0, which indicates low sensitivity to the automotive body performance. As described above, the element density of each of the elements calculated by the topology optimization serves an index representing the sensitivity of each of the elements with respect to the automotive body performance.

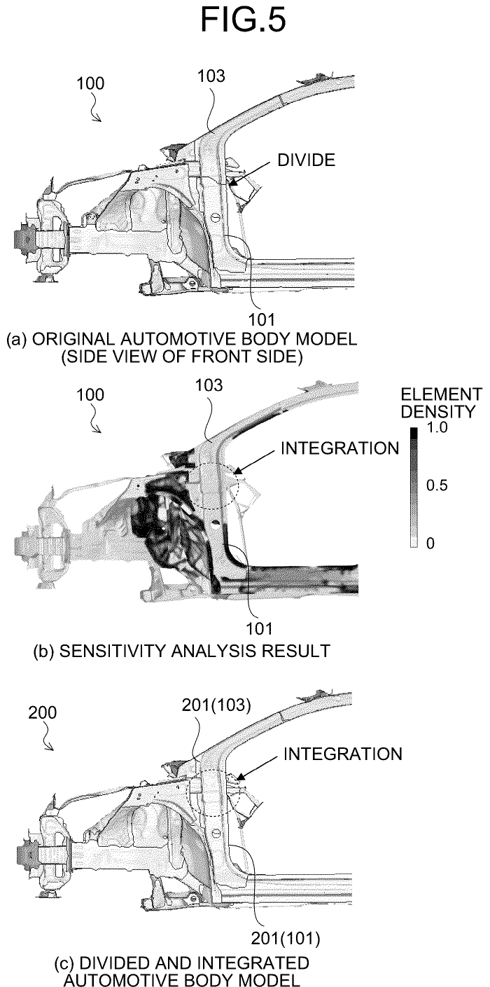

Illustrated in FIGS. 5(b), 6(b), and 7(b) as an example of sensitivity of elements calculated by the sensitivity analysis unit 15 is an example of a result of element densities calculated for elements of each of the automotive parts in a case where the objective is maximization of stiffness, and the constraint is a volume fraction ratio of 25%, and static torsion is applied to the automotive body model 100 under the load and constraint condition (absolute value of a load applied to each load point: 1000 N) illustrated in FIG. 4.

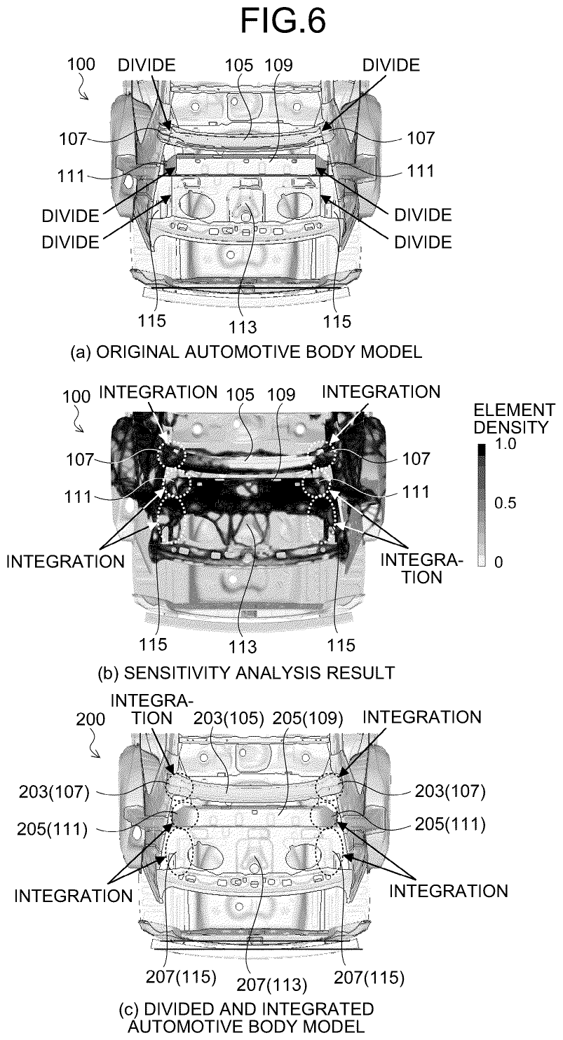

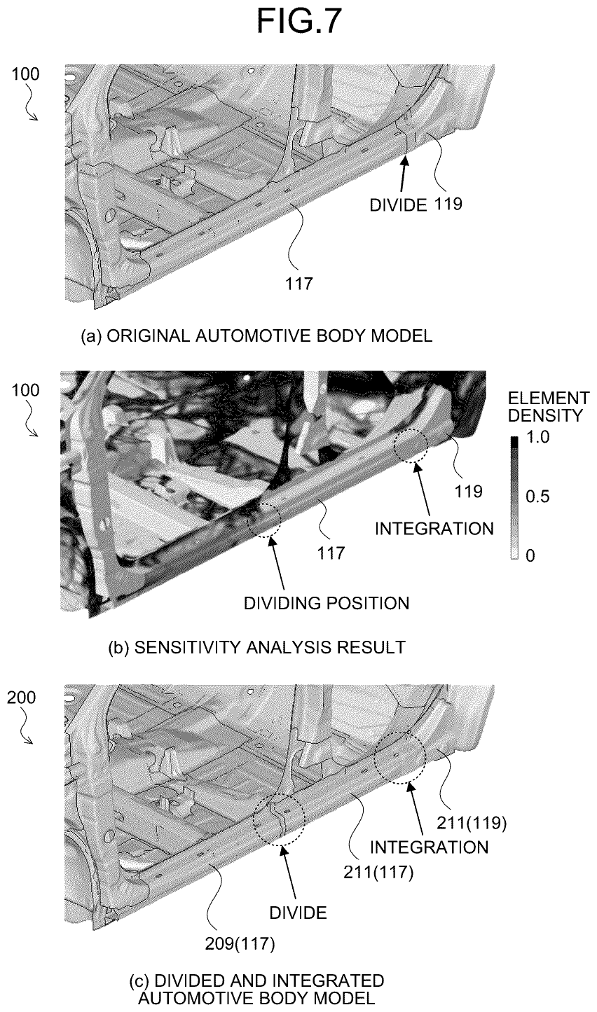

Incidentally, FIG. 5(b) is a side view of the A-pillar lower 101 and the A-pillar upper 103 (FIG. 5(a)) on the front side of the automotive body model 100, FIG. 6(b) is a top view of the rear side (FIG. 6(a)) of the automotive body model 100, and FIG. 7(b) is a perspective view of the side sill outer 117 and the wheel house reinforcement 119 (FIG. 7(a)) on the left side of the automotive body model 100.

As illustrated in FIGS. 5(b), 6(b), and 7(b), it can be seen that there are a region having high sensitivity to static torsion and a region having low sensitivity even in the same automotive part (for example, the side sill outer 117 illustrated in FIG. 7(b)) and that there are different automotive parts having substantially the same sensitivity as a whole (for example, the A-pillar lower 101 and the A-pillar upper 103 illustrated in FIG. 5(b)).

Note that the sensitivity analysis unit 15 may set only loading condition that takes inertia force when a dynamic load is applied to the automotive body model 100 by an inertia relief method into consideration. The inertial relief method is an analysis method for obtaining stress or strain from force acting on an object during constant acceleration motion in a state where the object is supported at a support point serving as a reference of coordinates of inertial force (free support) and is used for static analysis of an airplane or a ship in motion.

In addition, for calculating element densities of an element by the sensitivity analysis unit 15, analysis software for performing optimization analysis such as topology optimization can be used. In this case, each of the automotive parts included in the automotive body model 100 is set as a design space, element densities are given as a design variable to the elements included in the automotive parts that are set as the design space, and predetermined objectives, constraints, and load and constraint condition are set, whereby element densities are calculated as the sensitivity of the element.

Incidentally, in a case where the optimization analysis is performed in the sensitivity analysis unit 15, an optimization analysis method other than the topology optimization may be applied.

### (Automotive Part Dividing Position and Integration Determining Unit)

The automotive part dividing position and integration determining unit 17 determines a position at which automotive parts are divided and/or automotive parts to be integrated according to an instruction of an operator based on the sensitivity of each of the elements in the automotive parts obtained by the sensitivity analysis unit 15.

In determining the dividing position of automotive parts and automotive parts to be integrated based on the sensitivity, it is only required to set a difference in sensitivity as an index, to determine a position having a large difference in sensitivity in the same automotive part as a dividing position according to an instruction of the operator, and to determine to integrate adjacent automotive parts having a small difference in sensitivity.

In the present embodiment, a position where a difference in sensitivity in the automotive parts is greater than or equal to 0.7 is determined as a dividing position, and integration is determined in a case where a difference in sensitivity between adjacent automotive parts is less than or equal to 0.3.

Then, the automotive part dividing position and integration determining unit 17 creates new automotive parts by dividing an automotive part, for which a dividing position has been newly determined, at the dividing position, and integrates a plurality of automotive parts determined to be integrated into one automotive part.

A dividing position of automotive parts and automotive parts to be integrated are determined based on the sensitivity of the elements of the automotive parts illustrated in FIGS. 5(b), 6(b), and 7(b), and the results of the division and the integration of the automotive parts are illustrated in FIGS. 5(c), 6(c), and 7(c), respectively.

On the front side (FIG. 5(a)) of the automotive body model 100, as illustrated in FIG. 5(b), the difference in sensitivity (element densities) between the A-pillar lower 101 and the A-pillar upper 103 is as small as less than or equal to 0.3 (broken line ellipse in the figure).

Therefore, it is determined to integrate the A-pillar lower 101 and the A-pillar upper 103 to obtain an A-pillar 201 and as illustrated in FIG. 5(c).

On the rear side (FIG. 6(a)) of the automotive body model 100, as indicated by broken line ellipses in FIG. 6(b), the differences in sensitivity between the rear roof rail center 105 and the rear roof rail side 107, between the compartment center A 109 and the compartment side A 111, and between the compartment center B 113 and the compartment side B 115 are all as small as less than or equal to 0.3.

Therefore, it is determined to integrate each of the pairs of the rear roof rail center 105 and the rear roof rail side 107, the compartment center A 109 and the compartment side A 111, and the compartment center B 113 and the compartment side B 115 to obtain a rear roof rail 203, a compartment A 205, and a compartment B 207 as illustrated in FIG. 6(c).

On the left side (FIG. 7(a)) of the automotive body model 100, as indicated by broken line ellipses in FIG. 7(b), the difference in sensitivity between a front side and a rear side with respect to the approximate center of the side sill outer 117 is as large as greater than or equal to 0.7, and the difference in sensitivity between a rear part of the side sill outer 117 and the wheel house reinforcement 119 is as small as less than or equal to 0.3.

Therefore, as illustrated in FIG. 7(c), the approximate center where the difference in sensitivity is large in the side sill outer 117 is determined as a dividing position, and the front side is divided into a side sill outer front 209. Furthermore, a rear side with respect to the dividing position in the side sill outer 117 is determined to be integrated with the wheel house reinforcement 119 to obtain a side sill outer rear 211.

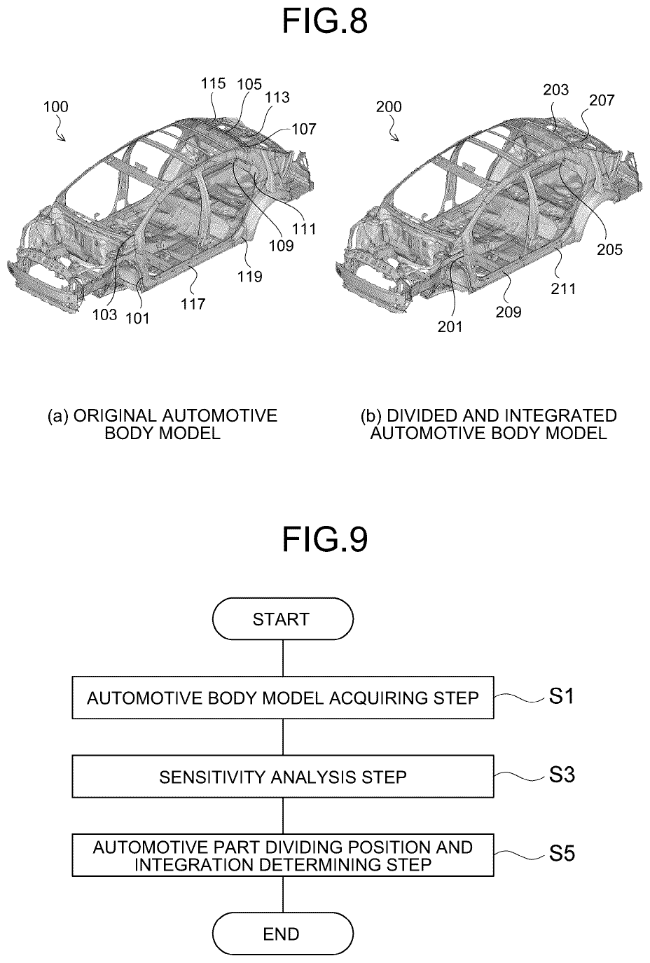

Illustrated in FIG. 8(b) is a general view of a divided and integrated automotive body model 200 after dividing positions and integration of automotive parts are determined based on the sensitivity illustrated in FIGS. 5(b), 6(b), and 7(b).

Note that, in the present embodiment, a position where the difference in sensitivity is greater than or equal to 0.7 in an automotive part is determined as a dividing position, and adjacent automotive parts where the difference in sensitivity is less than or equal to 0.3 are determined to be integrated. However, the difference in sensitivity for determining a dividing position or integration may be selected as appropriate.

### <Method for Determining Dividing Position and Integration of Automotive Parts>

Next, a dividing position and integration of automotive parts determination method according to the present embodiment will be described below.

The division and integration determining method for determining a dividing position and integration of automotive parts according to the present embodiment determines a dividing position of an automotive part and/or automotive parts to be integrated by a computer performing the following steps on an automotive body model including a plurality of automotive parts. As illustrated in FIG. 9, the method includes an automotive body model acquiring step S1, a sensitivity analysis step S3, and an automotive part dividing position and integration determining step S5. In the present embodiment, each of the above steps is executed by the division and integration determining device 1 (see FIG. 1) configured by a computer. Each of the above steps will be described below.

### <<Automotive Body Model Acquiring Step>>

The automotive body model acquiring step S1 is a step of acquiring an automotive body model including a plurality of automotive parts modeled by a plurality of elements and joining points at which the plurality of automotive parts are joined as the parts assembly. In the present embodiment, the automotive body model acquiring unit 13 of the division and integration determining device 1 acquires the automotive body model 100 including a plurality of automotive parts (A-pillar lower 101 and others) modeled by a plurality of shell elements and joining points 121 for joining the automotive parts as the parts assembly as exemplified in FIGS. 2 and 3(a) by reading the automotive body model file 21 (see FIG. 1).

### <<Sensitivity Analysis Step>>

The sensitivity analysis step S3 is a step of setting objectives regarding the automotive body performance of the automotive body model 100, constraints regarding the volume of the automotive body model 100, and load and constraint condition or only loading condition given to the automotive body model 100, and obtaining the sensitivity of each of the elements in each of the automotive parts satisfying the objectives under the set load and constraint condition or only loading condition and the constraints. In the present embodiment, the sensitivity analysis unit 15 of the division and integration determining device 1 sets the objectives, the constraints, and the load and constraint condition, and calculates element densities of each of the elements as the sensitivity of each of the elements.

In the sensitivity analysis step S3, optimization analysis such as topology optimization may be performed. In this case, it is only required that the automotive parts included in the automotive body model 100 are set as the design space, that element densities are given as a design variable to the elements included in the automotive parts set as the design space, whereby the optimization analysis processing is executed, and that element densities satisfying the objectives under the set constraints and load and constraint condition are calculated for each of the elements in the automotive parts.

### <<Automotive Part Dividing Position and Integration Determining Step>>

The automotive part dividing position and integration determining step S5 is a step of determining a position at which automotive parts are divided and/or automotive parts to be integrated by a computer according to an instruction of the operator based on the sensitivity of each of the elements in the automotive parts obtained in the sensitivity analysis step S3. In the present embodiment, the automotive part dividing position and integration determining unit 17 of the division and integration determining device 1 performs the step.

As described above, according to the method and the device for determining a dividing position and integration of automotive parts according to the present embodiment, by obtaining the sensitivity to the automotive body performance for each of the elements used for modeling the automotive parts, a dividing position of automotive parts and automotive parts to be integrated can be determined based on the obtained sensitivity of each of the elements in the automotive parts.

Then, by setting the sheet thickness or the material property for the divided automotive parts or the integrated automotive parts as appropriate according to the determination of the dividing position of the automotive part and the automotive parts to be integrated, it becomes possible to improve the automotive body performance efficiently and sufficiently.

For example, in a case where the sheet thickness of the divided automotive parts or the integrated automotive part is modified, the sheet thickness of the one having larger sensitivity out of the divided automotive parts may be increased due to a large contribution to the automotive body performance, and the sheet thickness of one having lower sensitivity out of the divided automotive parts or the integrated automotive parts may be decreased due to a small contribution to the automotive body performance.

Note that the method and the device for determining a dividing position and integration of automotive parts according to the present embodiment obtain the sensitivity of the elements in the automotive parts that affects the automotive body performance by modifying the sheet thickness or the material property. Therefore, a portion having high sensitivity greatly contributes to the automotive body performance, and thus the automotive body performance such as stiffness is improved by increasing the sheet thickness, and a portion having low sensitivity marginally contributes to the automotive body performance, and thus the automotive body performance such as stiffness does not decrease even if the sheet thickness is reduced.

In addition, in general, the automotive body performance is further improved (weight efficiency) with respect to an increase in mass caused by subdividing the automotive parts and increasing the sheet thickness of the divided automotive parts. However, there is a disadvantage that the total manufacturing cost increases by subdividing the automotive parts such as that the number of dies for press forming of the automotive parts increases and that the number of spot welding points for joining the automotive parts as the parts assembly increases. Meanwhile, according to the present invention, there is no need to reduce the division of the automotive parts more than necessary, and it is possible to increase the weight efficiency regarding the automotive body performance and to suppress an increase in the manufacturing cost.

Note that, although the sensitivity analysis is performed using the automotive body model 100, in which the joining points 121 are set, as it is, there may be a difference in sensitivity to the automotive body performance due to a difference in the number of joining points 121 set in the automotive body model.

Therefore, as another aspect of the present embodiment, as exemplified in FIG. 3(b), in addition to the joining points 121 stationed at intervals of 25 to 60 mm each, all additional joining points 151 capable of joining the parts assembly may be set to the acquired automotive body model 100, and sensitivity analysis may be performed using an automotive body model 150 simulating continuous joining of a plurality of automotive parts by setting to densify the joining points. Note that, in the automotive body model 150, 10932 additional joining points 151 are set at intervals of 10 mm each.

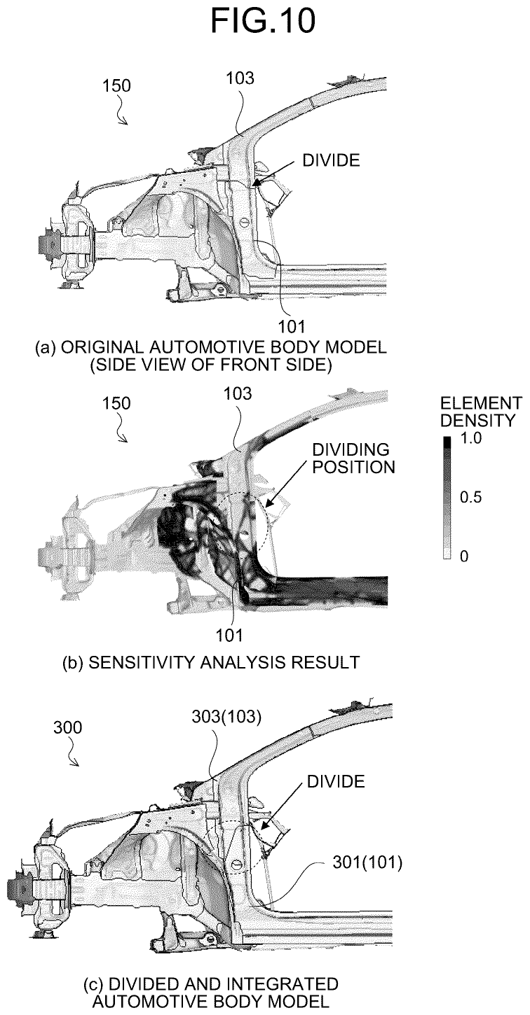

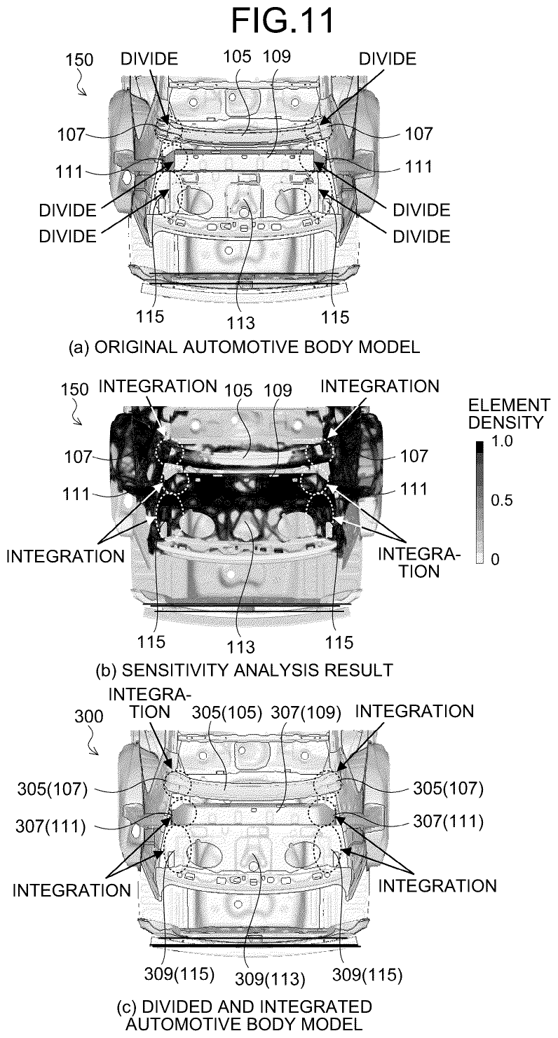

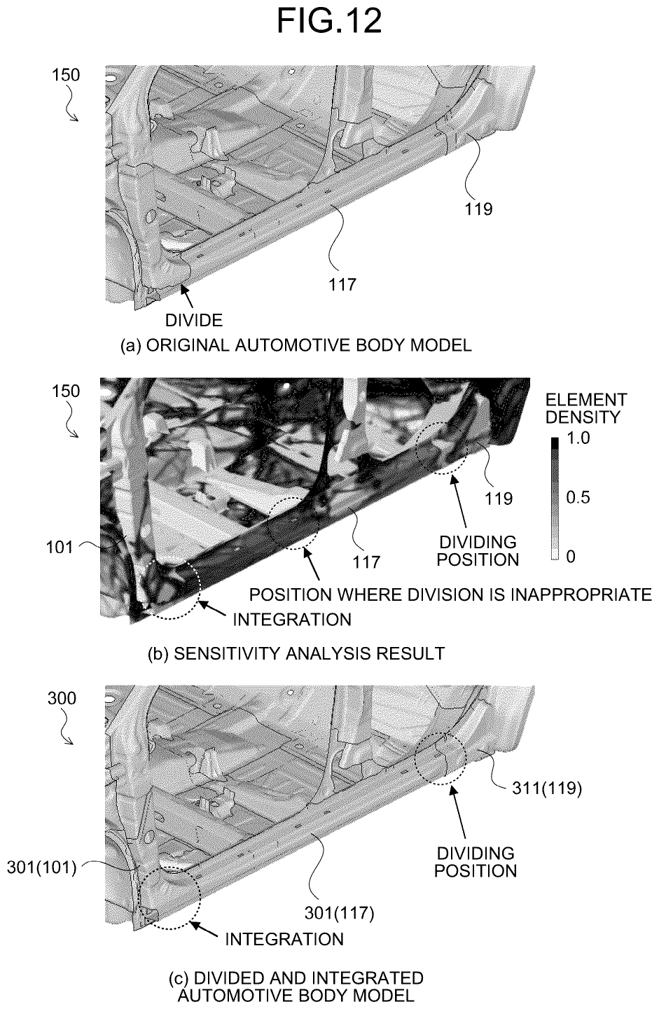

Illustrated in FIGS. 10(b), 11(b), and 12(b) is a result of a case where sensitivity analysis is performed using the automotive body model 150 obtained by setting the 10932 additional joining points 151 to the automotive body model 100 to determine a dividing position of automotive parts and automotive parts to be integrated. Incidentally, FIG. 10(b) is a side view of the A-pillar lower 101 and the A-pillar upper 103 (FIG. 10(a)) on the front side of the automotive body model 150, FIG. 11(b) is a top view of a rear side (FIG. 11(a)) of the automotive body model 150, and FIG. 12(b) is a perspective view of the side sill outer 117 and the wheel house reinforcement 119 (FIG. 12(a)) on the left side of the automotive body model 150. The sensitivities illustrated in FIGS. 10(b), 11(b), and 12(b) are obtained by setting the same objectives, constraints, and load and constraint condition (see FIG. 4) as those of the present embodiment described above. Note that the automotive parts in the automotive body model 150 are denoted by the same symbols as those of the automotive parts in the automotive body model 100 illustrated in FIG. 2.

On the front side (FIG. 10(a)) of the automotive body model 150, as illustrated in FIG. 10(b), the difference in sensitivity is as large as greater than or equal to 0.7 at a position different from the boundary between the A-pillar lower 101 and the A-pillar upper 103.

Therefore, the position where the difference in sensitivity is large is determined as a dividing position, and as illustrated in FIG. 10(c), an A-pillar lower 301 and an A-pillar upper 303 are obtained.

On the rear side (FIG. 11(a)) of the automotive body model 150, as illustrated in FIG. 11(b), the differences in sensitivity between the rear roof rail center 105 and the rear roof rail side 107, between the compartment center A 109 and the compartment side A 111, and between the compartment center B 113 and the compartment side B 115 are all as small as less than or equal to 0.3.

Therefore, as illustrated in FIG. 11(c), the rear roof rail center 105 and the rear roof rail side 107 are integrated to obtain a rear roof rail 305, the compartment center A 109 and the compartment side A 111 are integrated to obtain a compartment A 307, and the compartment center B 113 and the compartment side B 115 are integrated to obtain a compartment B 309.

On the left side of the automotive body model 150 (FIG. 12(a)), as illustrated in FIG. 12(b), the difference in sensitivity of the side sill outer 117 is as small as less than or equal to 0.3, and the difference in sensitivity between the rear portion of the side sill outer 117 and the wheel house reinforcement 119 is as large as greater than or equal to 0.7. Furthermore, the difference in sensitivity between the A-pillar lower 101 and a front portion of the side sill outer 117 is as small as less than or equal to 0.3.

Therefore, as illustrated in FIG. 12(c), the side sill outer 117 is not divided, and the side sill outer 117 and the wheel house reinforcement 119 are not integrated and are kept divided. The side sill outer 117 is integrated with the A-pillar lower 101 to obtain the A-pillar lower 301, and the wheel house reinforcement 119 is not integrated with the side sill outer 117 but set as a wheel house reinforce 311.

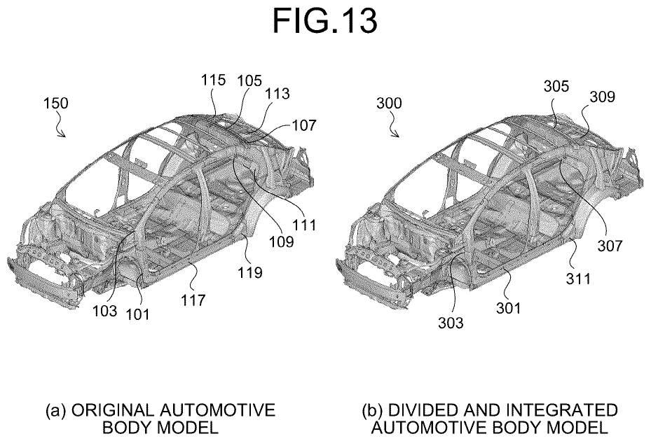

Illustrated in FIG. 13(b) is a general view of a divided and integrated automotive body model 300 after dividing positions and integration of automotive parts are determined based on the sensitivity illustrated in FIGS. 10(b), 11(b), and 12(b).

Note that a difference in operation and effect between a case where the automotive body model 100, in which the joining points 121 are set, described as the present embodiment is used as it is and a case where the automotive body model 150, in which all the additional joining points 151 where joining is possible are set, described as another aspect of the present embodiment is used will be described in examples described later.

In the above description, the improvement of the stiffness of the automotive body is targeted as the automotive body performance. However, in a case where improvement of the crash worthiness or fatigue properties is targeted as the automotive body performance, it is only required to set objectives regarding the crash worthiness or the fatigue properties in the sensitivity analysis unit or the sensitivity analysis step. For example, in a case where objectives regarding the crash worthiness are set, minimization of a displacement may be set as the objectives.

In addition, the sensitivity analysis unit 15 and the sensitivity analysis step S3 in the present embodiment are to calculate the element densities for each of the elements as the sensitivity of each of the elements. However, in the present invention, in a case where the automotive parts are modeled by the plurality of shell elements, the sheet thickness of each of the shell elements satisfying predetermined objectives, constraints, and load and constraint condition may be calculated, and the calculated sheet thickness of each of the shell elements may be used as the sensitivity of the element.

As described above, in a case where the sheet thickness of each of the shell elements obtained in the sensitivity analysis is used as the sensitivity, an element having a thick sheet thickness indicates that high sensitivity to the automotive body performance, and a shell element having a thin sheet thickness indicates that low sensitivity to the automotive body performance. As a result, the sheet thickness of each of the elements calculated in the sensitivity analysis can be an index representing the sensitivity of the element to the automotive body performance.

Furthermore, in the present embodiment, the sensitivity analysis unit 15 and the sensitivity analysis step S3 are to perform the sensitivity analysis by setting load and constraint condition for applying a static load, however, in the present invention, load and constraint condition corresponding to a dynamic load for vibrating the automotive body may be set.

Specifically, frequency response analysis or the like is performed on the automotive body model prior to the sensitivity analysis, and a position, a direction, and the magnitude of a load to be applied to the automotive body model corresponding to a deformation state in a vibration mode of the automotive body model obtained by the frequency response analysis or the like are determined. Then, it is only acquired to set the determined position, direction, and magnitude of the load to be applied as load and constraint condition and to perform sensitivity analysis.

### Example

An experiment for verifying the effect of the method and the device for determining a dividing position and integration of automotive parts according to the present invention was performed, which will be described below.

In the present example, improvement of the automotive body performance of the divided and integrated automotive body model 200 and the divided and integrated automotive body model 300 described in the embodiment as compared to the automotive body model 100 before the division and the integration was studied.

In the divided and integrated automotive body model 200 and the divided and integrated automotive body model 300, the sheet thickness of the automotive parts after the division was kept as the sheet thickness of the automotive parts before the division, and the integrated automotive parts were set to have a sheet thickness of an automotive part having a larger surface area among automotive parts before the integration.

Moreover, the load and constraint condition of the static torsion illustrated in FIG. 4 were applied to the divided and integrated automotive body model 200 and the divided and integrated automotive body model 300, and torsional stiffness was calculated. Incidentally, a load applied to a load point was set to 1000 N.

In this example, the torsional stiffness was calculated as follows. First, with a straight line connecting left and right rear subframe attachment positions (corresponding to Q in FIG. 4) of the divided and integrated automotive body model used as a reference (angle of 0 degrees), left and right front suspension attachment positions on the front side of the automotive body (corresponding to P in FIG. 4) were set as load points, and an inclination angle of the automotive body viewed from the front side of the automotive body, as of a time when a vertically upward load (1000 N) was applied to one of the load points and a vertically downward load (1000 N) was applied to the other load point, was averaged over the front-rear direction of the automotive body to obtain an average inclination angle. Then, a product of the loads applied to the load points and displacement was divided by the average inclination angle to obtain torsional stiffness.

Table 1 illustrates results of the mass change and the torsional stiffness in the divided and integrated automotive body model 200 and the divided and integrated automotive body model 300. Note that the interval between the joining points in each piece of the parts assembly of the automotive parts included in each of the divided and integrated automotive body model 200 and the divided and integrated automotive body model 300 is the same as the interval between the joining points 121 of the original automotive body model 100 given in advance.

TABLE 1

| | | | | Improve- | Improvement |
|---|---|---|---|---|---|
| | Automotive | | Torsional | ment | rate of |
| | body | Mass | stiffness | rate of | stiffness per |
| | mass | change | (kN · | stiffness | mass change |
| | (kg) | (kg) | m/deg) | (%) | (%/kg) |
| Reference | 299.8 | — | 24.78 | — | — |
| example | | | | | |
| Inventive | 302.1 | +2.3 | 28.01 | 13.02 | 5.66 |
| example 1 | | | | | |
| Inventive | 301.4 | +1.6 | 28.04 | 13.14 | 8.21 |
| example 2 | | | | | |

In Table 1, the reference example shows a result of a case where the original automotive body model 100 given in advance before division and integration was used, Inventive example 1 shows a result of a case where the divided and integrated automotive body model 200 was used, and Inventive example 2 shows a result of a case where the divided and integrated automotive body model 300 was used.

The mass change shown in Table 1 is a relative change of the mass of the divided and integrated automotive body model 200 or the divided and integrated automotive body model 300 based on the mass of the automotive body model 100 as the reference example, and the divided and integrated automotive body model 200 and the divided and integrated automotive body model 300 were calculated from the sheet thickness of the automotive parts.

Furthermore, the improvement rate of stiffness shown in Table 1 is a relative change in torsional stiffness obtained based on torsional stiffness of the original automotive body model 100 (reference example) before the automotive parts are divided or integrated, which was obtained from the following equation.

$$Improvement Rate of Stiffness ( \% ) = ( Torsional Stiffness of Inventive example - Torsional Stiffness of Reference Example ) / Torsional Stiffness of Reference Example \times 100$$

The improvement rates of stiffness per mass change in Inventive example 1 and Inventive example 2 were obtained by dividing the improvement rates of stiffness in Inventive example 1 and Inventive example 2 by the mass change, respectively.

The mass change in Inventive example 1 was 2.3 kg, and the mass change in Inventive example 2 was 1.6 kg. Although the mass was increased as compared with the reference example by dividing and/or integrating the automotive parts, the improvement rates of stiffness in Inventive example 1 and Inventive example 2 were both about 13%. As a result, the torsional stiffness was greatly improved by dividing and integrating the automotive parts according to the present invention.

The improvement rate of stiffness per mass change obtained by dividing the improvement rate of stiffness by the mass change was 5.66%/kg in Inventive example 1 and 8.21%/kg in Inventive example 2. From these results, it was found that the automotive body performance with respect to the mass change due to division and integration can be more efficiently improved in a case where sensitivity analysis is performed and a dividing position of an automotive part and automotive parts to be integrated are determined using the automotive body model 150 obtained by setting all the additional joining points 151, where joining can be performed, to the automotive body model 100 since the influence of the arrangement of the joining points on the automotive body performance can be eliminated, and the sensitivity of each of the elements of the automotive parts can be more accurately calculated.

### INDUSTRIAL APPLICABILITY

According to the present invention, it is possible to provide a method and a device for determining a dividing position and integration of automotive parts that can efficiently and sufficiently improve the automotive body performance.

### REFERENCE SIGNS LIST

1 DIVISION AND INTEGRATION DETERMINING DEVICE
3 DISPLAY DEVICE
5 INPUT DEVICE
7 MEMORY STORAGE
9 WORKING DATA MEMORY
11 ARITHMETIC PROCESSING UNIT
13 AUTOMOTIVE BODY MODEL ACQUIRING UNIT
15 SENSITIVITY ANALYSIS UNIT
17 AUTOMOTIVE PART DIVIDING POSITION AND INTEGRATION DETERMINING UNIT
21 AUTOMOTIVE BODY MODEL FILE
100 AUTOMOTIVE BODY MODEL
101 A-PILLAR LOWER
103 A-PILLAR UPPER
105 REAR ROOF RAIL CENTER
107 REAR ROOF RAIL SIDE
109 COMPARTMENT CENTER A
111 COMPARTMENT SIDE A
113 COMPARTMENT CENTER B
115 COMPARTMENT SIDE B
117 SIDE SILL OUTER
119 WHEEL HOUSE REINFORCEMENT
121 JOINING POINT
150 AUTOMOTIVE BODY MODEL
151 ADDITIONAL JOINING POINT
200 DIVIDED AND INTEGRATED AUTOMOTIVE BODY MODEL
201 A-PILLAR
203 REAR ROOF RAIL
205 COMPARTMENT A
207 COMPARTMENT B
209 SIDE SILL OUTER FRONT
211 SIDE SILL OUTER REAR
300 DIVIDED AND INTEGRATED AUTOMOTIVE BODY MODEL
301 A-PILLAR LOWER
303 A-PILLAR UPPER
305 REAR ROOF RAIL
307 COMPARTMENT A
309 COMPARTMENT B
311 WHEEL HOUSE REINFORCEMENT

1. A dividing position and integration of automotive parts determination method for determining a dividing position of an automotive part and/or automotive parts to be integrated by the following steps executed by a computer for an automotive body model including a plurality of the automotive parts, the method comprising:
an automotive body model acquiring step of acquiring the automotive body model including the plurality of automotive parts modeled by a plurality of elements and joining points at which the plurality of automotive parts are joined as a parts assembly;
a sensitivity analysis step of
setting objectives related to automotive body performance of the automotive body model, constraints related to a volume of the automotive body model, and load and constraint condition or only loading condition given to the automotive body model, and
obtaining sensitivity of each of the elements in each of the automotive parts satisfying the objectives under the load and constraint condition or only the loading condition and the constraints; and
an automotive part dividing position and integration determining step of determining a position where the automotive part is divided and/or the automotive parts to be integrated based on the sensitivity of each of the elements in each of the automotive part.

2. The dividing position and integration of automotive parts determination method according to claim 1, wherein, in the sensitivity analysis step, element densities of each of the elements satisfying the objectives are calculated, and the calculated element densities are used as the sensitivity of each of the elements.

3. The dividing position and integration of automotive parts determination method according to claim 1, wherein, in the automotive body model acquiring step, all additional joining points at which the parts assembly is able to be joined are set to the acquired automotive body model in addition to the joining points.

4. A dividing position and integration of automotive parts determination device for determining a dividing position of an automotive part and/or automotive parts to be integrated for an automotive body model including a plurality of the automotive parts, the device comprising:
an automotive body model acquiring unit configured to acquire the automotive body model including the plurality of automotive parts modeled by a plurality of elements and a joining point at which the plurality of automotive parts are joined as a parts assembly;
a sensitivity analysis unit configured to
set objectives related to automotive body performance of the automotive body model, constraints related to a volume of the automotive body model, and load and constraint condition or only loading condition given to the automotive body model, and
obtain sensitivity of each of the elements in each of the automotive parts satisfying the objectives under the load and constraint condition or only the loading condition and the constraints; and
an automotive part dividing position and integration determining unit configured to determine a position where the automotive part is divided and/or the automotive parts to be integrated by an instruction of an operator based on the sensitivity of each of the elements in each of the automotive parts.

5. The dividing position and integration of automotive parts determination device according to claim 4, wherein the sensitivity analysis unit is configured to
calculate element densities of each of the elements in each of the automotive parts satisfying the objectives, and
use the calculated element densities as the sensitivity of each of the elements.

6. The dividing position and integration of automotive parts determination device according to claim 4, wherein the automotive body model acquiring unit is configured to set all additional joining points at which the parts assembly is able to be joined to the acquired automotive body model in addition to the joining points.
